(19) United States
(12) Patent Application Publication
(10) Pub. No.: US 2022/0166242 A1
(43) Pub. Date: May 26, 2022

(54) DYNAMIC DISCHARGE RATE CONTROL

(71) Applicant: Microsoft Technology Licensing, LLC, Redmond, WA (US)

(72) Inventors: Gregory Allen NIELSEN, Kirkland, WA (US); Mika Juhani RINTAMAEKI, Redmond, WA (US); Donghwi KIM, Kirkland, WA (US); Minsoo KIM, Bothell, WA (US); Sean Patrick BYRNES, Seattle, WA (US)

(21) Appl. No.: 16/953,932

(22) Filed: Nov. 20, 2020

(51) Int. Cl. H02J 7/00

(52) U.S. Cl. CPC H02J 7/00712; H02J 7/0063

(57) ABSTRACT

A method for improved electronic device performance provides for sampling a power consumption parameter for a device throughout a time interval in which an increased load transient is observed and for dynamically calculating one or more exponential weighted moving averages (EWMAs) based on the power consumption parameter responsive to each sampling. The method further provides for increasing a maximum discharge rate of the battery to a discharge rate limit associated with a select maximum level of multiple predefined discharge rate levels and then incrementally decreasing the maximum discharge rate of the battery from the discharge rate limit of the select maximum level to one or more lower discharge rate limits associated with progressively lower levels of the multiple predefined discharge rate levels.

### BACKGROUND

Electronic devices are typically designed to permit batteries to discharge at rates set in accordance with battery manufacturer specifications. For example, some devices impose either a continuous or a maximum battery discharge rate that is based on battery capacity. Often the discharge current rate of the battery is expressed as the C-Rate, where 1 C implies that a fully charged battery rated at 1 Ampere-hour may be fully discharged by providing 1 Amp of current for one hour. To protect battery health, current systems rarely permit batteries to discharge at rates higher than 1 C.

### SUMMARY

A method of toggling battery discharge rate to improve device performance without degrading the battery provides for sampling a power consumption parameter for a device throughout a time interval in which an increased load transient is observed. The method further provides for dynamically calculating one or more exponential weighted moving averages (EWMAs) based on the power consumption parameter responsive to each sampling of the power consumption parameter; increasing a maximum discharge rate of the battery to a discharge rate limit associated with a select maximum level of multiple predefined discharge rate levels; and as the EWMAs increase following the increased load transient, incrementally decreasing the maximum discharge rate of the battery from the discharge rate limit of the select maximum level to one or more lower discharge rate limits associated with progressively lower levels of the multiple predefined discharge rate levels.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other implementations are also described and recited herein.

### BRIEF DESCRIPTION OF THE DRAWINGS

FIG. 1 illustrates an example processing device that increases performance by temporarily allowing battery discharge at high rates and incrementally reducing the discharge rate over time based on dynamically calculated exponential weighted moving averages (EWMAs) for a power consumption parameter.

FIG. 2 illustrates exemplary actions of a power management system that dynamically throttles battery discharge rate according to a set of restraints designed to improve system performance while also protecting the battery from degradation.

FIG. 3 illustrates an exemplary plot of exponential weighted moving averages (EWMAs) calculated with respect to a power consumption parameter and different discharge levels in a system that dynamically throttles battery discharge rate.

FIG. 4 illustrates a plot illustrating a performance boost gained versus limiting to a fixed 1 C discharge limit by implementing the methodology described above with respect to the specific examples given in FIG. 2 and FIG. 3.

FIG. 5 is an exemplary plot illustrating a further extension of the examples shown in FIG. 2-4 where the initial load stops for a bit (at t7) and a second high load is experienced at a later time (t8).

FIG. 6 illustrates yet another example plot of exponential weighted moving averages (EWMAs) calculated with respect to a power consumption parameter and different discharge levels in a system that dynamically throttles battery discharge rate.

FIG. 7 illustrates aspects of another example system that dynamically throttles battery discharge rate to improve system performance while also imposing restraints that protect the battery from degradation.

FIG. 8 illustrates exemplary operations for altering a battery discharge rate target to improve system performance while also protecting the battery from degradation.

FIG. 9 illustrates an example computing environment suitable for implementing aspects of the disclosed technology.

### DETAILED DESCRIPTION

There are some applications where significant device performance can be realized by permitting a battery to temporarily discharge at a discharge rate higher that the ˜1 C; however, extended periods of battery discharge at rates higher than 1 C can lead to battery degradation. Moreover, sudden and steep drops in the battery discharge rate, such as from a high level (e.g., 1.4 C) to a nominal discharge level (e.g., 1 C or lower) can impact the user experience. If for example, the user is interacting with a graphics-heavy application, a sudden drop in battery discharge rate may translate to a reduction in the frame rate, which may be distracting and undesirable to the user.

The herein disclosed technology provides methods of temporarily throttling battery discharge rate to high C-Rate levels (higher than 1 C) to improve system performance while also systematically limiting the time the battery spends discharging at higher levels so as to not subject the battery to degradation that could unnecessarily shorten the battery lifetime. The disclosed battery discharge throttling methods also provide for gradual and controlled reduction of the discharge rate from the high C-Rate levels so as to prevent any disruption to the user experience that might otherwise be observed due to changes in frame rate that result from sudden drops from high to low C-Rate levels.

According to one implementation, the foregoing is achieved by sampling a power consumption parameter and dynamically calculating a set of exponential weighted moving averages (EWMA) that are based on the power consumption parameter on an ongoing basis throughout a time interval. Each of the different EWMAs in the set are computed using a different averaging constant that causes a corresponding exponential curve to increase at a slightly different rate. Each of the EWMA curves is associated with a preselected discharge rate limit, where the progressively steeper (quicker-rising) EWMA curves correlate with progressively higher discharge rate limits. In this sense, the EWMA curve that increases the fastest hits its associated discharge rate limit first, the EWMA curve that increases the second-fastest hits its associated limit second, and so on As is described in further detail below, these EWMAs may inform system selection of power limits during active device operation such that the battery discharge rate depends—at each point in time—on the computed exponential weighted moving averages of the power consumption parameter. When the EWMAs are lower, the battery may be permitted to discharge at higher rates to boost system performance; when the EWMAs are higher, more stringent battery discharge limits may be imposed to protect the battery. This provides a desirable device performance boost without putting the battery at high risk of degradation.

In one example implementation, the battery discharge rate may be temporarily increased above the nominal range (above 1 C) when a sudden load transient is observed to provide a temporary boost to device performance. Then, as the EWMAs increase, the maximum discharge rate level is dynamically reduced each time one of the dynamically-calculated EWMAs hits its associated discharge rate limit. This results in a stair-step back-off function, gradually decreasing the battery discharge rate until the discharge rate is back in the nominal rage (at or less than 1 C).

According to one implementation, the averaging constant associated with the EWMA curve of each different discharge rate level is specially tailored to ensure that the time the battery spends discharging at each of the discharge rate limits is less than a maximum duration prespecified in accord with that limit. For example, a battery test team may determine that the battery can be safely discharged at 1.4 C for up to 8 seconds before there is a risk of degradation, up to 15 seconds at 1.3 C before there is a risk of degradation, etc. To implement these caps on each different discharge rate level, the averaging constants for the EWMAs are chosen such each curve rises to its discharge rate limit in a select predefined amount of time. The battery discharge rate is incrementally decreased each time one of the EWMAs reaches its associated limit. As will be explored with respect to the following figures, this serves to cap the amount of time that the battery discharges at each predefined level, ultimately protecting the battery while still providing the system with a significant performance boost over systems that cap maximum discharge rates at or near 1 C.

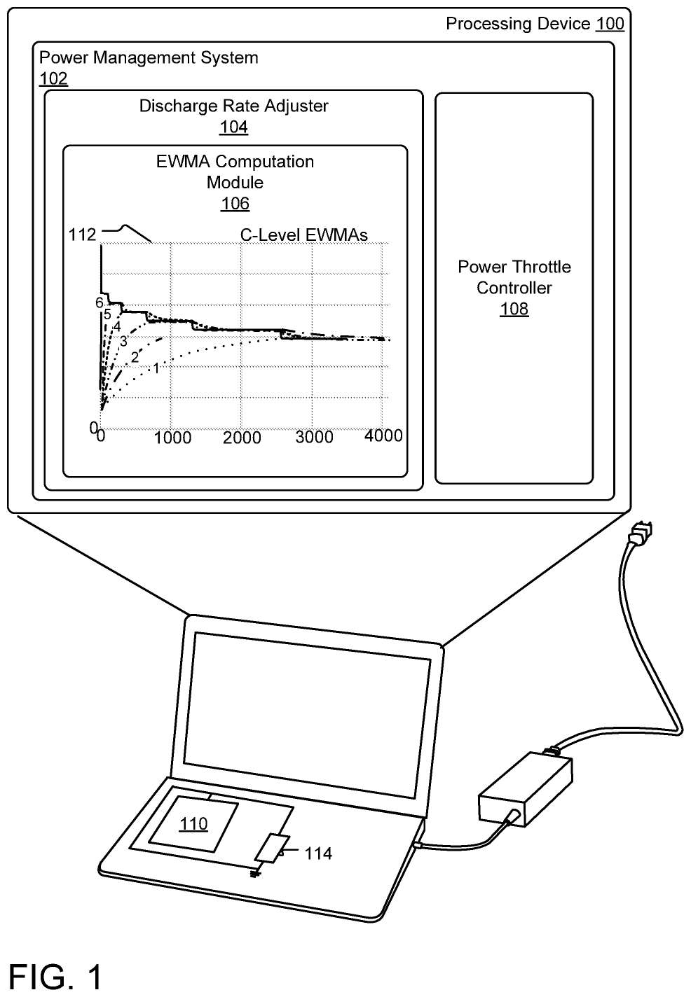

FIG. 1 illustrates an example processing device 100 with power management controls that boost device performance by temporarily allowing battery discharge at high rates and incrementally reducing the discharge rate over time based on dynamically calculated exponential weighted moving averages (EWMAs) for a power consumption parameter. As used herein, a power consumption parameter may be understood as including any variable usable to quantify how much power is being consumed within a system including, for example, current and power. The processing device 100 is shown to be a laptop computer but may, in other implementations, be any battery-powered electronic device. Although the processing device 100 is shown to include a single battery (e.g., battery 114), other devices implementing the technology may include multiple batteries with the same or disparate charge characteristics in a variety of different arrangements.

The processing device 100 includes a power management system 102, which includes at least a discharge rate adjuster 104 and an exponential weighted moving average (EWMA) computation module 106. Each of the discharge rate adjuster 104 and the discharge rate adjuster 104 may be understood as include software and/or hardware components, with the software components being stored in memory of the processing device 100 and executed by a local processor. In some implementations, aspects of the discharge rate adjuster 104 and/or EWMA computation module 106 may be stored and/or executed remotely, such as at a cloud-based server. The power management system 102 further includes a power throttle controller 108, which may be understood as including at least hardware that is selectively controlled by the discharge rate adjuster 104 to transmit control signals that serve to throttle the discharge rate of the battery 104.

For example, the power throttle controller 108 may include a proportional-integral-derivative (PID) controller that employs a feedback in a control loop to continuously calculate and reduce a difference between a measured parameter (e.g., battery discharge current) and a power system setpoint (e.g., a setpoint for maximum discharge current), where the setpoint is based on calculations of the discharge rate adjuster 104. For example, the PID controller may receive as an input a reference value representing the battery discharge current at the present time. This value may, for example, be obtained from integrated circuitry inside that battery pack that monitors battery discharge current and power. Alternatively, control electronics may read the battery discharge current from a system charger, such as over and I2C communication channel, and provide this measured value to the PID controller.

In one implementation, power throttling of system components is implemented by software at the driver level based on outputs from the PID controller; in other implementations, power throttling is performed by a separate embedded controller with the power levels (caps) output from the PID being implemented within the system via SMBUS, eSPI or other communication methods to the CPU, GPU, and other load-drawing components.

According to one implementation, the discharge rate adjuster 104 continuously samples a power consumption parameter, such as a current that is drawn from the battery 114 by system load electronics 110. The discharge rate adjuster 102 provides each new sample value to the EWMA computation module 106, and the EWMA computation module 106 uses the sampled value to dynamically compute an exponential weighted moving average (EWMA) in association with each of multiple predefined discharge rate levels. In the illustrated example, the EWMA computation module 106 dynamically computes 6 different EWMAs. Each of the EWMAs is calculated with a different averaging constant defined such that the six different EWMAs can be plotted (based on updates to the same power consumption parameter) as six different exponential curves that are labeled in plot 112 of FIG. 1 with numerals 1, 2, 3, 4, 5, and 6. These different exponential curves are also referred to herein as discharge rate levels or simply “levels” (level 1, level 2, etc.) The variation in the shape of the EWMA curves (1-6) is due to the fact that each of the EWMAs is computing based on a different averaging constant, the purpose of which is explained further detail below.

According to one implementation, each of the discharge rate levels 1-6 is associated with a predefined discharge rate limit. The discharge rate adjuster 104 is configured to dynamically throttle a maximum discharge rate limit of the battery 114 between these different levels based on power consumption activity of the processing device 100. By example and without limitation, FIG. 1 illustrates a scenario with a maximum discharge rate limit that is set at a time when the processing device 100 experiences low power demands for a set period of time.

When a system load of the device 100 increases, the discharge rate controller 104 may provide the power throttle controller 108 with an instruction to temporarily increase certain system power limits (e.g., power limits pertaining to the GPU, CPU, memory, display brightness, external loads), resulting in a corresponding increase in battery discharge. This increase in battery discharge is, in one implementation, capped by the current setpoint of the maximum discharge rate limit (managed dynamically by the discharge rate adjuster). Notably, battery discharge rate is controlled by the system to meet the load based on the currently-imposed system power limits.

As the discharge rate of the battery 114 increases, the EWMA computation module 106 dynamically samples the power consumption parameter and, responsive to each sampling, computes a data point for each one of the 6 different EWMA curves. The EWMAs begin to increase. The EWMA with the steepest slope (e.g., level 6) hits its discharge rate limit first. At this point in time, the discharge rate adjuster 104 instructs the power throttle controller 106 to reduce the maximum discharge rate limit for the battery 114 to the level 5 discharge rate limit. This is repeated at each level. For example, when the EWMA for level 5 hits the level 5 discharge rate limit a few seconds later, the maximum discharge rate limit for the battery 114 is reduced to the level 4 discharge rate limit. Again, when the EWMA for level 4 hits the level 4 discharge rate limit, the maximum discharge rate limit for the battery 114 is reduced to the level 3 discharge rate limit, and so on. In this way, the battery discharge rate is incrementally reduced according to a stair-step back-off function.

Over time, as the system power demands drop and the EWMAs again fall back to nominal levels (e.g., at or less than 1 C), the maximum discharge rate limit for the battery 116 may be increased as the EMWAs allow. According to one implementation, the maximum discharge rate limit for the battery 116 is—at any given time—set to equal the discharge rate limit of a highest one of the predefined discharge rate levels for which the current EWMA value that does not exceed the level's associated discharge rate limit. If, for example, the EMWA for level 4 exceeds the discharge rate limit for level 4 while the EWMA limit for level 3 is less than the discharge rate limit for level 3, the maximum discharge rate limit for the battery 116 is set to equal the limit of discharge rate limit set for level 3. This is explored in further detail with respect to the following figures.

By allowing the battery to temporarily discharge above nominal discharge rate levels (e.g., above 1 C), the processing device 100 may gain significant performance benefits, such as to allow for rendering of high quality graphics without reducing a frame rate at times when power demands are especially high. At the same time, incrementally decreasing (backing off) the battery discharge rate as described above effectively caps the total amount of time that the battery 116 discharges at each discharge rate to a predefined maximum duration, thereby protecting the battery from degradation. The use of this gradual back-off in discharge rate (e.g., stair-step function) ensures no noticeable effect to the user (e.g., no sudden/dramatic drops in frame rate).

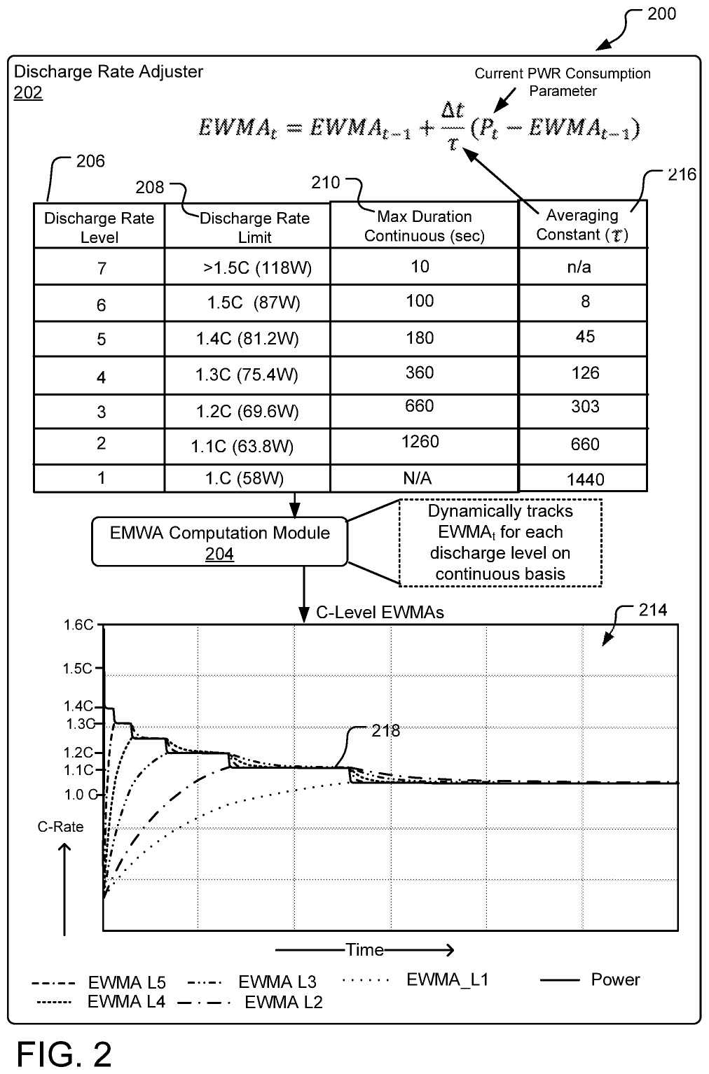

FIG. 2 illustrates exemplary actions of a power management system 200 that dynamically throttles battery discharge rate according to a set of restraints designed to improve system performance while also protecting the battery from degradation. The power management system 200 includes a discharge rate adjuster 202 that continuously samples a power consumption parameter of an electronic device. For example, the discharge rate adjuster 202 may continuously sample a power demand of a source load (e.g., current that is drawn by source load electronics) that is supported—in full or in part—by a battery (not shown).

The discharge rate adjuster 202 provides each new sample value to an EWMA computation module 204, which in turn, uses the sample value to dynamically compute multiple different exponential weighted moving average (EWMA) values in association with each of multiple predefined discharge rate levels. By example and without limitation, FIG. 2 illustrates a table 206 illustrating seven different discharge rate levels (1-7) for which an EWMA may be computed based on a same sampled value of the power consumption parameter. Each discharge rate level (e.g., 1-7) is associated with a predefined discharge rate limit 208. The discharge rate levels are merely exemplary. Although 7 levels are shown in FIG. 2, other implementations may define fewer or greater numbers of discharge levels that are individually associated with discharge rate limits different than those shown.

The discharge rate limits shown in the table 206 are further associated with a maximum continuous duration 210 of discharge (e.g., in seconds), which are in one implementation, determined experimentally. For example, a battery manufacturer or device power management team may perform tests for an individual battery or capacity/type of battery to determine a maximum amount of time that the battery can continuously spend each of various different discharge rates without incurring a risk of battery degradation. In the illustrated example, it is determined that the battery can spend no more 10 seconds continuously discharging above 1.5 C, which translates to 118 W for a 58-Watt battery. Likewise, the battery may discharge at 1.5 C for no more than 100 seconds, at 1.4 C for no more than 180 seconds, at 1.3 C for no more than 360 seconds, and so on, before incurring a potential risk of battery degradation. The final column in table 206 represents an averaging constant 212 that is predefined in association with each of the discharge rate levels (1-7) to ensure that the battery does not—per the below methodology—discharge at the associated level (e.g., at the discharge rate limit 208 set for the level) for a continuous duration that is longer than the maximum continuous duration 210 that is set in association with that level. The averaging constant 212 is discussed in further detail below.

Upon receipt of each sampled value of the power consumption parameter, the EWMA computation module 204 computes an EWMA for each of the discharge rate levels. According to one example methodology, the EWMA for each level is computed using equation (1) below:

$${EWMA}_{t} = {EWMA}_{t - 1} + \frac{Δ t}{τ} ( {P}_{t} - {EWMA}_{t - 1} ) \qquad ( 1 )$$

where Δt is the rate of sampling (e.g., 1 if sampling occurs once per second), τ is the averaging constant defined for each level in table 206, Pₜ is the current value of the sampled power parameter, and EWMAₜ₋₁ is the previous EWMA computed based on the previous sample value for the power consumption parameter (Pₜ−1).

A plot 214 illustrates example EWMA curves generated for the illustrated levels 1-5 using the same set of sample values for the power consumption parameter (Pₜ) and the averaging constants 216 shown in the table 206. Notably, EWMA curves for levels 6 and 7 are so close to overlapping with the Y-axis that they are simply not visible in the plot 214. Due to the use of the different averaging constants (τ), the different EWMA curves each rise to their associated discharge rate limit 208 in a different amount of time. The averaging constants 216 are specifically chosen such that the EWMA for level 6 reaches its limit (1.5 C) first, followed by the EWMA for level 5 (1.4 C), followed by the EWMA for level 4 (1.3 C), etc.

According to one implementation, the discharge rate adjuster 202 sets a flag to instruct hardware components to incrementally lower a maximum discharge rate limit of the battery (e.g., a cap on total system power consumption 218) each time one of the dynamically-computed EWMA curves hits its associated discharge rate limit 208.

By example and without limitation, the plot 214 indicates that of the 6 EWMAs dynamically computed using equation (1) above for each of levels 1-6, level 6 is the first EWMA to reach its associated discharge rate limit of 1.5 C. At this point in time, a flag is set to reduce a maximum discharge rate of the battery to the discharge rate limit for level 5, which is 1.4 C. At a later point in time, the EWMA for level 5 reaches its associated discharge rate limit of 1.4 C and another flag is set to reduce the maximum discharge rate of the battery to the discharge rate limit for level 4, which is 1.3 C. This continues as each of the EWMA limits is successively reached, until the maximum discharge rate has been backed-off back down to a nominal, safe discharge rate (e.g., 1.0 C). Each reduction of the maximum discharge rate limit corresponds to one of the “stairs” in the back-off function shown in the plot 214 (e.g., where the stair-step back-off function represents device power consumption).

Due to the pre-selected averaging constant T that is set for each level (1-6), each successive discharge rate limit (e.g., level 6, level 5, level 4 . . . ) is reached within a set amount of time (delta) relative to the previously limit, such that this value (delta) is guaranteed to be shorter than the maximum continuous duration 210 that is set in association with the previous limit. For example, the EWMA for level 3 reaches its discharge rate limit of 1.2 C within 260 seconds of the time that the EWMA for level 4 reaches its limit of 1.3 C, and the EWMA for level 2 reaches its discharge rate limit of 1.1 C within 660 seconds of the time that the EWMA for level 3 reaches its limit of 1.2 C. As a result, the battery does not continuously discharge longer than 360 seconds at 1.3 C and does not continuously discharge longer than 660 second at 1.2 C.

In sum, the above methodology imposes an incremental (gradual) stair-step back-off from an initial maximum battery discharge rate down to nominal discharge rate of ˜1.0 C. This controlled, incremental discharge rate back-off effectively restricts the duration of battery discharge at each of the discharge rate limits 208 to total continuous time duration that is shorter than the associated maximum continuous duration 210. Consequently, the system may still experience a significant temporary performance boost by discharging the battery at higher than 1 C (e.g., up to 1.5 C or higher) without risking degradation of the battery that could shorten the effective battery lifetime.

Other aspects of the discharge rate adjuster 202 may be considered the same or similar to those described elsewhere herein with respect to other implementations.

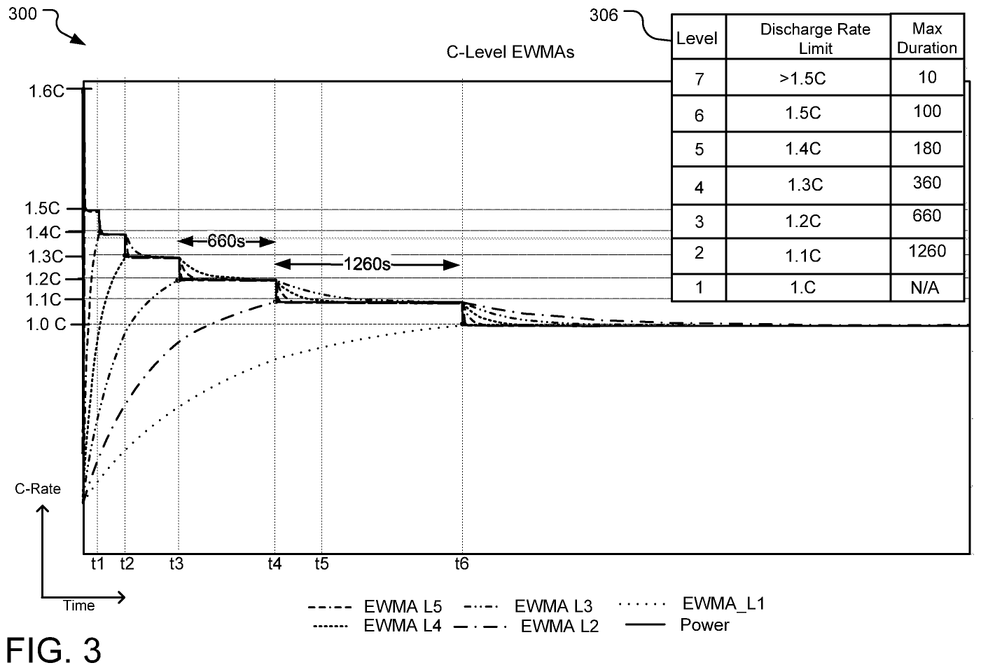

FIG. 3 illustrates aspects of the example of FIG. 2 in greater detail. Specifically, FIG. 3 illustrates a plot 300 showing a magnified view of the same information shown in the plot 214 of FIG. 2. The plot 300 illustrates various different EWMA curves. These EWMA curves that are computed dynamically, based on a repeatedly sampled power consumption parameter of an electronic device. The five illustrated EWMA curves may be understood as corresponding to discharge levels 1-5 shown in FIG. 2, where each of the respective discharge levels has a predefined discharge rate limit (as shown in table 206 of FIG. 2) and is computed with a different averaging constant (as also shown in table 206 of FIG. 2). Notably, the EWMA curve for level 6 is not visible on the plot 300 due to the fact that it largely overlaps the y-axis.

In the present example, the device has been previously operating in a substantially low power state such that previous values of the 6 EWMAs are very low. At time t0, source electronics of the device experience a large load transient, resulting in an increased draw on a battery voltage rail up to 1.7 C (as shown near t0 on the plot 300).

A power management system of the device implements predefined rules to determine whether to permit the battery to discharge at a rate greater than nominal (greater than 1.0 C) in order to provide better device performance for a duration of time corresponding to the increased load transient or instead. According to one implementation, the power management system may permit a temporary increase in the battery discharge rate up to a currently-set maximum discharge rate limit.

As explained above with respect to FIG. 2, the maximum discharge rate limit may be dynamically altered based on power consumption activity of the electronic device. In one implementation, the maximum discharge rate limit is initially set to a default absolute maximum and then gradually reduced in time to the various limits associated with the pre-set discharge rate levels (e.g., the limits shown in table 306). The power management system may, in different implementations, utilize different mechanisms to control the current maximum discharge rate limit. In one implementation, the power management system manages the maximum discharge rate limit by tracking the existence or non-existence of a flag in association with each of the different discharge rate levels (e.g., 1-7). A flag set in association with a given level indicates that the battery is not currently permitted to discharge at the discharge rate limit for that level. If, for example, a flag is currently set in association with the discharge rate limit (1.5 C) of level 6 but no flag is set in association with the discharge rate limit (1.4 C) of level 5, the maximum discharge rate limit is interpreted as being 1.4 C (for level 5).

Notably, the “maximum discharge rate limit” may be understood as corresponding to the solid line in the plot 300 that is labeled in the graph key as “Power” (e.g., device power consumption). In the event that the device has a single battery that independently supports the full source load, the battery discharge current may precisely correlate with the “Power” line shown in the plot 300. In implementations where the device has an alternate power source in addition to the battery, the “power” line on the plot 300 may be understood as representing the combined current from the alternate power sources. However, even in these implementation, the system may dynamically alter a “maximum discharge rate limit” of the battery that causes the total system power to follow a stair-step back-off approach, as shown.

Returning to the example of FIG. 3, the system begins computing EWMAs based on the dynamically-sampled power consumption parameter (e.g., sampled at each 1 second) and the averaging constant that is set in association with each of the different EWMA curves, as shown and discussed in FIG. 2.

Since the maximum discharge rate limit for the battery is, at time t1, set to at or above 1.6 C, the system permits a temporary increase in the battery discharge rate up to ˜1.6 C or to an amount approximately sufficient to support the increased load without reducing GPU and/or CPU power setpoints. At a time t1 (e.g., within 10 seconds of t0), the EWMA for level 6 hits its discharge rate limit of 1.5 C. In response, the power management system sets a flag that reduces the maximum discharge rate limit of the battery to 1.4 C. At a later time t2 (e.g., within 100 seconds of t1) the EWMA for level 5 hits its discharge rate limit of 1.4 C. In response, the power management system sets a flag that reduces the maximum discharge rate limit of the battery to 1.3 C. At a later time t3 (e.g., within 180 seconds of t2) the EWMA for level 4 hits its discharge rate limit of 1.3 C. In response, the power management system sets a flag that reduces the maximum discharge rate limit of the battery to 1.2 C. At still another later time t4 (e.g., within 360 seconds of t3) the EWMA for level 3 hits its discharge rate limit of 1.2 C. In response, the power management system sets a flag that reduces the maximum discharge rate limit of the battery to 1.1 C. Subsequently, at time t5, (e.g., within 660 seconds of t4) the EWMA for level 3 hits its discharge rate limit of 1.2 C. In response, the power management system sets a flag that reduces the maximum discharge rate limit of the battery to 1.1 C. Finally, at time t6, (e.g., within 1260 seconds of t5) the EWMA for level 2 hits its discharge rate limit of 1.1 C. In response, the power management system sets a flag that reduces the maximum discharge rate limit of the battery to 1.0 C.

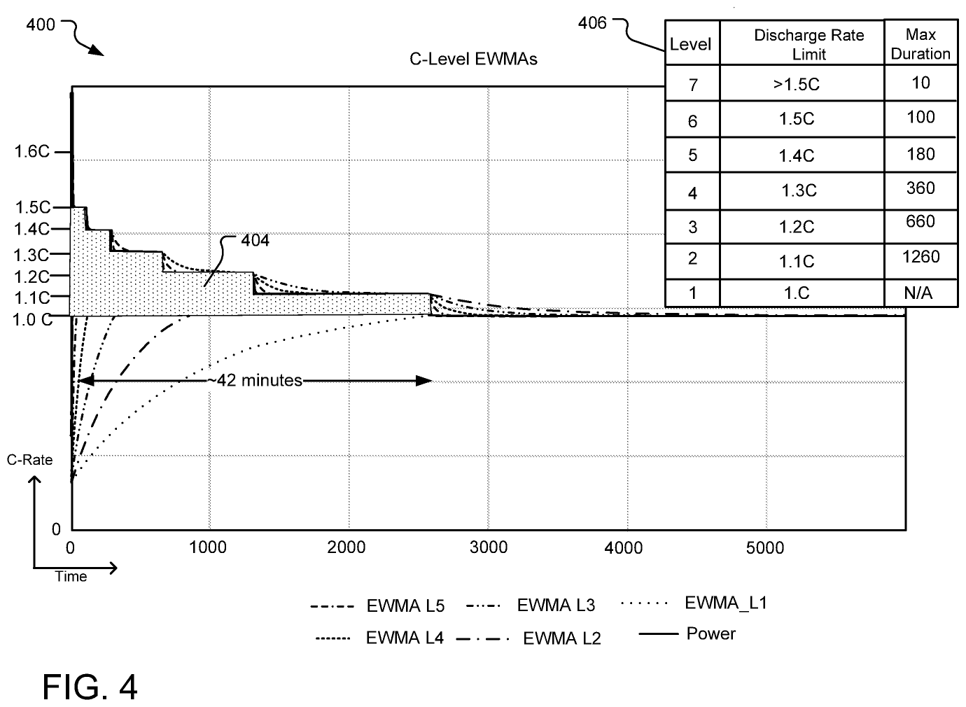

FIG. 4 illustrates a plot 400 illustrating a performance boost gained versus limiting to a fixed 1 C battery discharge limit by implementing the methodology described above with respect to the specific examples given in FIG. 2 and FIG. 3. By example and without limitation, the plot 400 illustrates that when the discharge rate levels, limits, and averaging constants are set as described in FIGS. 2 and 3, the battery is permitted to discharge at a rate higher than 1.0 C for approximately 42 minutes, while the maximum continuous duration of time spent at each of the discharge rate limits corresponding to levels 1-6 is capped to at or below the pre-defined value set in association with each level in the table 406. That is, the entire solid-filled area 404 of the plot 402 corresponds to a performance gain of the device that is realized as a direct result of the above-described methodology. These gains are achieved without a corresponding risk of battery degradation. Moreover, by “backing off” of the initial maximum discharge rate (e.g., around t0) incrementally rather than all at once, noticeable disruptions to the user experience are mitigated or avoided entirely.

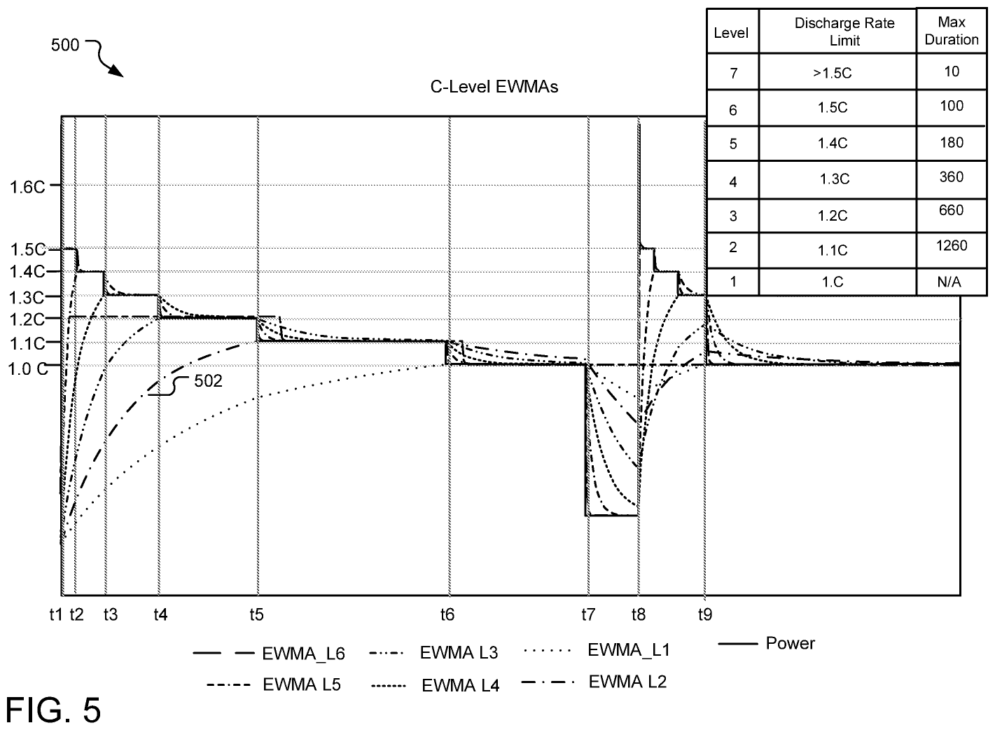

FIG. 5 is an exemplary plot 500 illustrating a further extension of the examples shown in FIG. 2-4. In FIG. 5, a power management system responds to a second load transient, which may be understood as occurring subsequent to power management activities the same or similar to those described above. Notably, the plot 500 includes time-stamps t0-t6 that generally correspond to an initial increase in a system load transient and response consistent with that described above with respect to FIG. 2-4. After the system load decreases and returns to a low level (e.g., less than 1 C), the EWMAs begin to decrease.

According to one implementation, the power management system uses dynamically computed EWMA values (as described with respect to any of FIG. 1-4) to determine when to again conditionally permit increases in the discharge rate of the battery. Provided that the EWMA for a given discharge rate level (e.g., as given by equation 1) is less than the discharge rate limit predefined in association with that level, the battery is permitted to conditional discharge at that level. Thus, although the power management system may incrementally reduce the maximum discharge rate limit of the battery as the EWMAs rise (as described above with respect to FIG. 3), the maximum discharge rate limit may be incrementally increased as the EWMAs begin to fall again. For example, the maximum discharge rate limit may be lowered by setting a flag when the EWMA for level 5 (e.g., curve 502) reaches its limit of 1.1 C at t5. However, once then EWMA for level 5 drops back below 1.1 C (e.g., just after t6) this flag may be removed, allowing the battery discharge rate to again rise back to 1.1 C to as needed to support future load transients.

Since the EWMA curves for the higher discharge rate levels (e.g., EWMA curves for level 6, 5, 4) drop more quickly than the EWMA curves for the lower discharge rate levels, budget may be regained more quickly with respect to the higher discharge levels than the lower levels. In the illustrated example, a second increased load transient is observed at time t8. Since the EWMA for the highest level (level 6) has fallen to below the 1.5 C limit, the power management system temporarily increases the maximum discharge rate limit of the battery to meet the increased demand of the load. However, as soon as the level 6 EWMA curve again hits the 1.5 C limit, a flag is set to drop the maximum discharge rate limit down to the discharge rate limit of level 5 (1.4 C), and incremental back-off continues as described above with respect to FIG. 2-4. Since the EWMAs has not—prior to time t8—fallen quite as low prior to the initial load increase (e.g., at t0), the EWMAs reach their associated discharge rate limits more quickly following t8 than following t0. Thus, the total continuous duration of time at which the maximum discharge rate limit is maintained at discharge levels 6, 5, and 4 is shorter between times t8 and t9 than in the previous iteration (between t0 and t3). Moreover, since the EWMAs for levels 3 and 2 have do not fall below their associated limits at any time t8 through t9, the maximum battery discharge rate limit is not set to target these levels, instead skipping from the L4 discharge rate limit (e.g., 1.3 C) down to the L1 discharge rate limit (1.0 C).

The above methodology for incrementally and conditionally raising the maximum discharge rate limit based on the EWMA values ensures that the battery does not degrade due to repeated extended usage at each of the discharge rate limits.

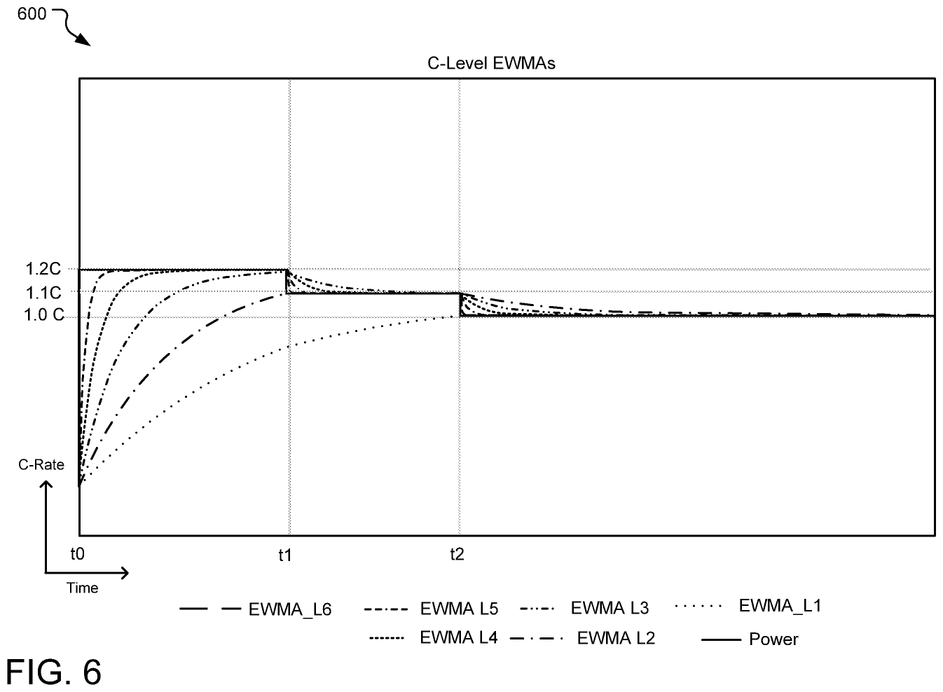

FIG. 6 illustrates yet another example plot 600 of EWMAs of a power consumption parameter calculated for different discharge levels in a system that dynamically throttles battery discharge rate, such as in a manner the same or similar to that described with respect to FIG. 1-5. Features of the system used to generate the plot 600 may be assumed to be the same or similar as those discussed above with respect to any of FIG. 1-5. The plot 600 illustrates EMWAs computed responsive to a low-level system load. Between times t0 and t1, none of the EWMAs reach their associated limits. As such, the maximum discharge rate limit of the battery initially remains fixed at a value that is higher than amount of current that is needed to support the system load. However, at time t1 the EWMA for Level 3 (L3) reaches its discharge rate limit and the maximum discharge rate limit 602 is dropped down to the limit associated with Level 2 (L2). At subsequent time t2, the EWMA for Level L2 (L2) reaches its discharge rate limit and the maximum discharge rate limit 602 is dropped down to the limit associated with Level 1 (L1). Since system power demand is low throughout the interval shown (e.g., compared to the power demand illustrated with respect to FIG. 5), the maximum discharge rate limit is maintained for a maximum continuous duration at both of the L2 and L3 limits.

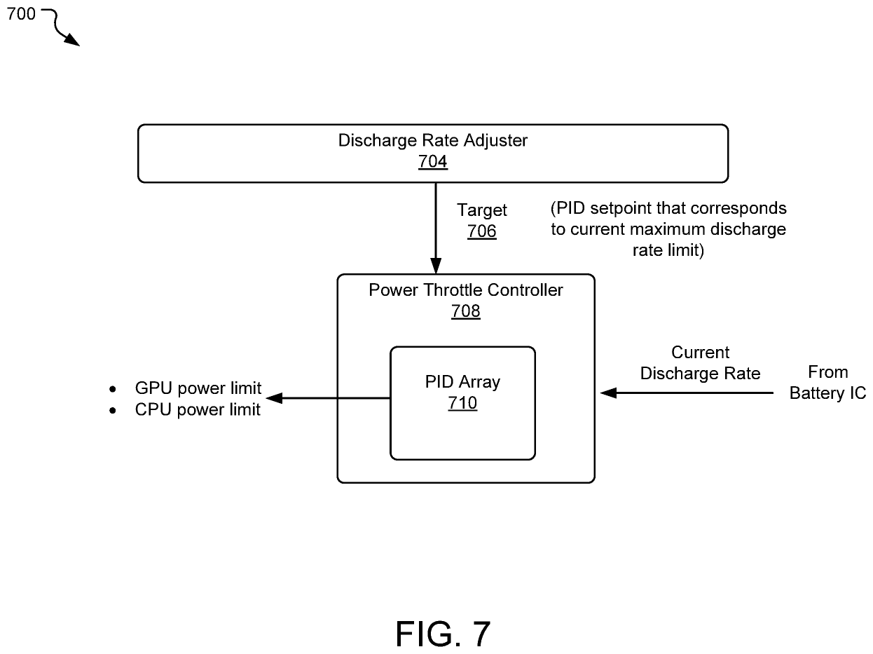

FIG. 7 illustrates aspects of another example system 700 that dynamically throttles battery discharge rate to improve system performance while also imposing restraints that protect the battery from degradation. The system includes a discharge rate adjuster 704 that performs actions the same or similar to those described with respect to the discharge rate adjusters of FIGS. 1 and 2. Primarily, the discharge rate adjuster 704 dynamically samples a power consumption parameter and, based on the power consumption parameter, determines a current maximum discharge rate limit for the battery. At various times, the discharge rate adjuster 704 may dynamically increase or decrease the maximum discharge rate for the battery based on EWMA values that are computer for the power parameter.

The discharge rate adjuster 704 selects a target 706 that corresponds to the maximum discharge rate limit. The target 706 increases as the maximum discharge rate limit increases and decreases as the maximum discharge rate limit decrease. The target 706 is provided to a power throttle controller 708 that sets system power limits that govern the battery discharge rate throughout system operations. The target setpoint is typically set based on discharge current, amperage, or power (watts).

The power throttle controller 708 includes a PID array 710 that accepts the target 706 as well as a measured power parameter, such as a value representing the battery discharge current at the present time. Based on these two inputs, the PID array 710 implements logic to select power settings that, when implemented, effect proportional alterations in the battery discharge current. The PID array 710 outputs a power cap value representing a maximum power that is to be allocated to the source load electronics. This power cap value is, in turn, translated by firmware of the power throttle controller 708 into power settings for different device components (e.g., GPU power limit, CPU power limit). These power settings ensure the select power cap is met within the system and thereby ultimately ensure that the battery discharges at or just below the current maximum discharge rate limit. According to one implementation, the PID array 710 tries to hold the system power consumption level to match the target 706 by throttling CPU and/or GPU power limits.

In various implementations, the power throttle controller 708 may implement various mechanisms for noise filtering, such as to reduce the total number of discharge rate variations (transitions) and to aid in smoother (less jumpy) transitions between different power settings and discharge rates. For example, the power throttle controller 708 may average several consecutively-received inputs from the battery before adjusting power settings. In another implementation, the power throttle controller 708 throttles the power settings based on the battery's reported average discharge rate. For example, the power throttle controller 708 communicates with fuel gauge IC on the battery to retrieve the average discharge rate and throttles the power settings to reduce system power at times when the battery's average discharge rate exceeds the current maximum discharge rate limit. In this latter scenario, the power throttle controller 708 relies on the averaging algorithm provided in the fuel gauge IC by the battery manufacturer.

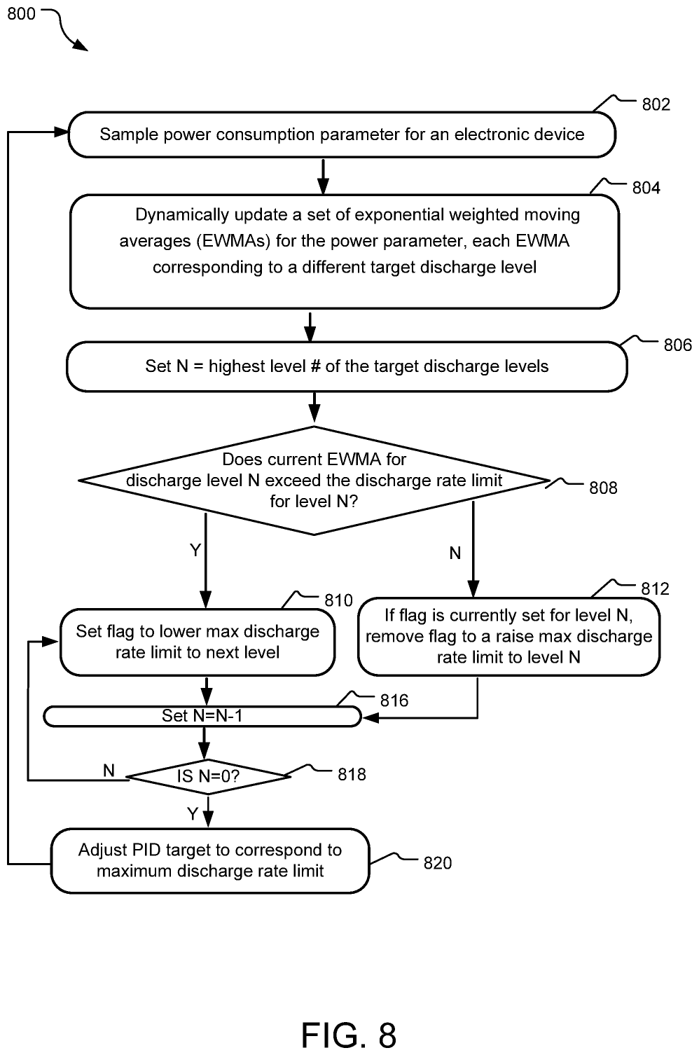

FIG. 8 illustrates exemplary operations 800 for altering a battery discharge rate target that boosts system performance while also protecting the battery from degradation. According to one implementation, the operations 800 are performed by a discharge rate adjuster (e.g., software module) that determines and dynamically updates a target input to a PID controller. The PID controller, in turn, throttles system power systems (e.g., alters CPU and GPU limits) to try to limit battery discharge to at or near the target.

A sampling operation 802 samples a power consumption parameter for an electronic device. The sampling is performed with regular periodicity, such as once per second. In one implementation, the power consumption parameter sampled is source load current. In another implementation, the power consumption parameter sampled is temperature. A computation operation 804 dynamically computes a set of exponential weighted moving averages (EWMAs) for the power consumption parameter. Each EWMA is computed with a different averaging constant defined in association with a different target discharge level. Each of the different target discharge levels is further associated with a discharge rate limit (e.g., a target that may be selectively provided as input to the PID controller). Further aspects of the computed EWMAs may be the same or similar to those discussed with respect to other implementations herein.

A variable setting operation 804 initializes a counter value (N) to equal an integer representing a highest one of the target discharge levels. If, for example, the discharge levels are 1-7 where level 1 has the lowest discharge rate limit and level 7 has the highest discharge rate limit, the variable setting operation 804 initializes N to 7.

A determination operation 808 determines whether the EWMA computed for level N (e.g., by the computation operation 804) exceeds the discharge rate limit for level N. If so, a flag setting operation 8102 sets a flag that lowers a maximum discharge rate limit of the battery to the limit associated with the next lowest discharge level (e.g., N−1). If, for example, the EWMA for Level 6 exceeds the Level 6 discharge rate limit of 1.5 C, the flag is set to effectively lower the maximum discharge rate limit of the battery to the discharge rate limit of level 5 (e.g., 1.4 C if using the exemplary limits shown in FIG. 2-5).

If, however, the determination operation 808 determines that the EWMA computed for level N does not exceed the discharge rate limit for level N, a flag check and removal operation 812 checks to see if a flag is currently set for Level N. If such a flag is set, the flag is removed, effectively raising the maximum discharge rate of the battery to include the discharge rate limit for level N.

A variable update operation 816 re-initializes the N value to N=N−1. Provided that a determination operation 818 determines that the updated N is still greater than 0, the determination operation 808 repeats, assessing the EWMA for the next lowest discharge level. The operations 808-818 repeat again (for each remaining discharge level) with respect to the same updated set of EWMAs.

Once the determination operation 818 determines that the updated N is 0 (e.g., the EWMA has been assessed for each level), a PID target adjustment operation 820 adjust input to a PID controller to alter a target setpoint for battery discharge to correspond to the maximum discharge rate limit that was determined throughout the above-described operations. If, for example, the above cycle of operations resulted in the setting of flags for discharge levels 7, 6, and 5, the PID target adjustment operation may provide input to the PID controller that reduces the target discharge rate to a setpoint that causes system power to roughly equal the discharge rate limit for level 4. Alternatively, if the above cycle of operations resulted in the removal of a flag for discharge level 5, the PID target adjustment operation may provide input to the PID controller that increases the target setpoint such that system power is roughly capped by the level 5 discharge rate limit.

Notably, the PID target adjustment operation 820 may be skipped if there has been no change in the maximum discharge rate limit since the previous execution of the PID target adjustment operation 820. Moreover, the PID controller may—in some implementations—implement noise filtering logic, such as by altering the target setpoint based on an average of several inputs rather than a single input as shown and described with respect to FIG. 8.

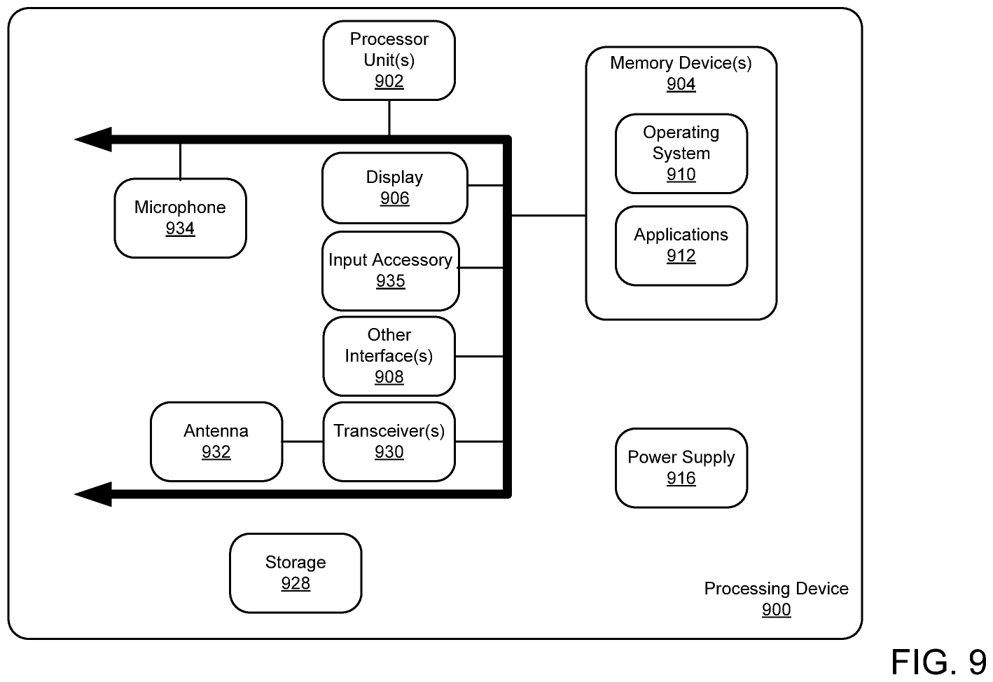

FIG. 9 illustrates an example schematic of a processing device 900 suitable for implementing aspects of the disclosed technology. The processing device 900 includes one or more processor unit(s) 902, memory 904, a display 906, and other interfaces 908 (e.g., buttons). The memory 904 generally includes both volatile memory (e.g., RAM) and non-volatile memory (e.g., flash memory). An operating system 910, such as the Microsoft Windows® operating system, the Microsoft Windows® Phone operating system or a specific operating system designed for a gaming device, resides in the memory 904 and is executed by the processor unit(s) 902, although it should be understood that other operating systems may be employed.

One or more applications 912, such as the battery discharge rate adjuster 104 of FIG. 1 or EWMA computation module 106 of FIG. 1 are loaded in the memory 904 and executed on the operating system 910 by the processor unit(s) 902. The applications 912 may receive input from various input devices such as a microphone 934 or input accessory 936 (e.g., keypad, mouse, stylus, touchpad, gamepad, racing wheel, joystick). The processing device 900 includes a power supply 916, which is powered by one or more batteries or other power sources and which provides power to other components of the processing device 900. The power supply 916 may also be connected to an external power source that overrides or recharges the built-in batteries or other power sources.

The processing device 900 includes one or more communication transceivers 930 and an antenna 932 which may provide network connectivity (e.g., a mobile phone network, Wi-Fi®, Bluetooth®). The processing device 900 may also include various other components, such as a positioning system (e.g., a global positioning satellite transceiver), one or more accelerometers, one or more cameras, an audio interface (e.g., a microphone 934, an audio amplifier and speaker and/or audio jack), and storage devices 928. Other configurations may also be employed.

In an example implementation, a mobile operating system, various applications and other modules and services may have hardware and/or software embodied by instructions stored in memory 904 and/or storage devices 928 and processed by the processor unit(s) 902. The memory 904 may be memory of host device or of an accessory that couples to a host.

The processing device 900 may include a variety of tangible computer-readable storage media and intangible computer-readable communication signals. Tangible computer-readable storage can be embodied by any available media that can be accessed by the processing device 900 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 900. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example method disclosed herein provides for sampling a power consumption parameter for a device throughout a time interval in which an increased load transient is observed and for dynamically calculating one or more exponential weighted moving averages (EWMAs) based on the power consumption parameter responsive to each sampling. The method further provides for increasing a maximum discharge rate of a battery to a discharge rate limit associated with a select maximum level of multiple predefined discharge rate levels. As the EWMAs increase following the increased load transient, the maximum discharge rate of the battery is incrementally decreased from the discharge rate limit of the select maximum level to one or more lower discharge rate limits associated with progressively lower levels of the multiple predefined discharge rate levels.

In one example method of any preceding method, dynamically calculating one or more EWMAs further comprises calculating a plurality of EWMAs based on the sampled power consumption parameter. Each one of the plurality of EWMAs is associated with a different one of the multiple predefined discharge rate levels and a different one of multiple discharge rate limits. Additionally, each one of the EWMAs defines an exponential curve that rises to the corresponding discharge rate limit in a different amount of time.

In another example method of any preceding method, each of the plurality of EWMAs is calculated based on a different averaging constant. The averaging constants are defined to ensure that the EWMAs associated with progressively higher discharge levels each reach associated discharge rate limits in progressively shorter time increments.

In another example method of any preceding method, the method further provides for determining that the EWMA for a particular one of the multiple predefined discharge rate levels has exceeded an associated discharge rate limit and setting a flag to prohibit battery from discharging at or above the associated discharge rate limit until the EWMA for the discharge rate level again drops below the associated discharge rate limit.

In yet still another example method of any preceding method, a length of time that the discharge rate is maintained at each of the multiple discharge rate limits is based on the averaging constant that is predefined with respect to each of the multiple predefined discharge rate levels.

In yet still another example method of any preceding method, incrementally decreasing the discharge rate of the battery further comprises: incrementally decreasing a discharge rate of the battery to cap a maximum time duration that the battery spends continuously discharging at each of the multiple discharge rate limits each defined in association with one of the multiple predefined discharge rate levels.

In yet still another example method of any preceding method, incrementally decreasing the discharge rate of the battery further comprises decreasing a discharge rate of the battery responsive to determining that a select one of the plurality of EWMAs has reached the corresponding discharge rate limit of the multiple discharge rate limits.

An example system disclosed herein includes a power controller configured to sample a power consumption parameter for a device throughout a time interval in which an increased load transient is observed; dynamically calculate one or more exponential weighted moving averages (EWMAs) based on the power consumption parameter responsive to each sampling of the power consumption parameter; increase a maximum discharge rate of a battery to a discharge rate limit associated with a select maximum level of multiple predefined discharge rate levels; and as the EWMAs increase following the increased load transient, incrementally decrease the maximum discharge rate of the battery from the discharge rate limit of the select maximum level to one or more lower discharge rate limits associated with progressively lower levels of the multiple predefined discharge rate levels.

In one example system of any preceding system, the power controller is further configured to update a plurality of EWMAs based on the sampled power consumption parameter throughout the time interval, each one of the plurality of EWMAs being associated with a different one of the multiple predefined discharge rate levels and defining an exponential curve that rises to a corresponding one of multiple discharge rate limits in a different amount of time.

In another example system of any preceding system, each of the plurality of EWMAs is calculated based on a different averaging constant, the different averaging constants being defined to ensure that the EWMAs associated with progressively higher discharge levels each reach associated discharge rate limits in progressively shorter time increments.

In still yet another example system of any preceding system, a length of time that the discharge rate is maintained at each of the multiple discharge rate limits is based on the averaging constant that is predefined with respect to each of the multiple predefined discharge rate levels.

In yet still another example system of any preceding system, incrementally decreasing the discharge rate of the battery further comprises: incrementally decreasing a discharge rate of the battery to cap a maximum time duration that the battery spends continuously discharging at each of the multiple discharge rate limits each defined in association with one of the multiple predefined discharge rate levels.

In yet still another example system of any preceding system, the power controller is further configured to determine that the EWMA for a particular one of the multiple predefined discharge rate levels has exceeded an associated discharge rate limit and prohibit the discharge rate of the battery from discharging at the associated discharge rate limit until the EWMA for the discharge rate level again drops below the associated discharge rate limit.

In yet still another example system of any preceding system, the power controller is further configured to decrease a discharge rate of the battery responsive to determining that a select one of the plurality of EWMAs has reached the corresponding discharge rate limit of the multiple discharge rate limits.

An example more computer-readable storage media disclosed herein stores computer-executable instructions for executing a computer process comprising: sampling a power consumption parameter for a device throughout a time interval in which an increased load transient is observed; dynamically calculating one or more exponential weighted moving averages (EWMAs) based on the power consumption parameter responsive to each sampling of the power consumption parameter; increasing a maximum discharge rate of a battery to a discharge rate limit associated with a select maximum level of multiple predefined discharge rate levels; and as the EWMAs increase following the increased load transient, incrementally decreasing the maximum discharge rate of the battery from the discharge rate limit of the select maximum level to one or more lower discharge rate limits associated with progressively lower levels of the multiple predefined discharge rate levels.

In an example computer-readable storage media of any preceding computer-readable storage media, the encoded computer process further comprises calculating a plurality of EWMAs based on the sampled power consumption parameter, each one of the plurality of EWMAs being associated with a different one of the multiple predefined discharge rate levels and defining an exponential curve that rises to a corresponding one of multiple discharge rate limits in a different amount of time.

In yet still another example computer-readable storage media of any preceding computer-readable storage media, each of the plurality of EWMAs is calculated based on a different averaging constant. The averaging constants are defined to ensure that the EWMAs associated with progressively higher discharge levels each reach associated discharge rate limits in progressively shorter time increments.

In yet still another example computer-readable storage media of any preceding computer-readable storage media, a length of time that the discharge rate is maintained at each of the multiple discharge rate limits is based on the averaging constant that is predefined with respect to each of the multiple predefined discharge rate levels.

In yet still another example computer-readable storage media of any computer-readable storage media, incrementally decreasing the discharge rate of the battery further comprises: incrementally decreasing a discharge rate of the battery to cap a maximum time duration that the battery spends continuously discharging at each of the multiple discharge rate limits each defined in association with one of the multiple predefined discharge rate levels.

In yet still another example computer-readable storage media of any computer-readable storage media, the encoded computer process further comprises determining that the EWMA for a particular one of the multiple predefined discharge rate levels has exceeded an associated discharge rate limit and prohibiting the discharge rate of the battery from discharging at the associated discharge rate limit until the EWMA for the discharge rate level again drops below the associated discharge rate limit.

An example system disclosed herein includes a means for sampling a power consumption parameter for a device throughout a time interval in which an increased load transient is observed; a means for dynamically calculating one or more exponential weighted moving averages (EWMAs) based on the power consumption parameter responsive to each sampling of the power consumption parameter; a means for increasing a maximum discharge rate of a battery to a discharge rate limit associated with a select maximum level of multiple predefined discharge rate levels; and a means for incrementally decreasing the maximum discharge rate of the battery from the discharge rate limit of the select maximum level to one or more lower discharge rate limits associated with progressively lower levels of the multiple predefined discharge rate levels as the EWMAs increase following the increased load transient.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A method comprising:
sampling a power consumption parameter for a device throughout a time interval in which an increased load transient is observed;
dynamically calculating one or more exponential weighted moving averages (EWMAs) based on the power consumption parameter responsive to each sampling of the power consumption parameter;
increasing a maximum discharge rate of a battery to a discharge rate limit associated with a select maximum level of multiple predefined discharge rate levels; and
as the EWMAs increase following the increased load transient, incrementally decreasing the maximum discharge rate of the battery from the discharge rate limit of the select maximum level to one or more lower discharge rate limits associated with progressively lower levels of the multiple predefined discharge rate levels.

2. The method of claim 1, wherein dynamically calculating one or more EWMAs further comprises:
calculating a plurality of EWMAs based on the sampled power consumption parameter, each one of the plurality of EWMAs being associated with a different one of the multiple predefined discharge rate levels and a different one of multiple discharge rate limits, each of the EWMAs defining an exponential curve that rises to the corresponding discharge rate limit in a different amount of time.

3. The method of claim 2, wherein each of the plurality of EWMAs is calculated based on a different averaging constant, the averaging constants being defined to ensure that the EWMAs associated with progressively higher discharge levels each reach associated discharge rate limits in progressively shorter time increments.

4. The method of claim 1, further comprising:
determining that the EWMA for a particular one of the multiple predefined discharge rate levels has exceeded an associated discharge rate limit;
setting a flag to prohibit battery from discharging at or above the associated discharge rate limit until the EWMA for the discharge rate level again drops below the associated discharge rate limit.

5. The method of claim 3, wherein a length of time that the discharge rate is maintained at each of the multiple discharge rate limits is based on the averaging constant that is predefined with respect to each of the multiple predefined discharge rate levels.

6. The method of claim 2, wherein incrementally decreasing the discharge rate of the battery further comprises: incrementally decreasing a discharge rate of the battery to cap a maximum time duration that the battery spends continuously discharging at each of the multiple discharge rate limits each defined in association with one of the multiple predefined discharge rate levels.

7. The method of claim 2, wherein incrementally decreasing the discharge rate of the battery further comprises:
decreasing a discharge rate of the battery responsive to determining that a select one of the plurality of EWMAs has reached the corresponding discharge rate limit of the multiple discharge rate limits.

8. A system comprising:
a power controller configured to:
sample a power consumption parameter for a device throughout a time interval in which an increased load transient is observed;
dynamically calculate one or more exponential weighted moving averages (EWMAs) based on the power consumption parameter responsive to each sampling of the power consumption parameter;
increase a maximum discharge rate of a battery to a discharge rate limit associated with a select maximum level of multiple predefined discharge rate levels; and
as the EWMAs increase following the increased load transient, incrementally decrease the maximum discharge rate of the battery from the discharge rate limit of the select maximum level to one or more lower discharge rate limits associated with progressively lower levels of the multiple predefined discharge rate levels.

9. The system of claim 8, wherein the power controller is further configured to:
update a plurality of EWMAs based on the sampled power consumption parameter throughout the time interval, each one of the plurality of EWMAs being associated with a different one of the multiple predefined discharge rate levels and defining an exponential curve that rises to a corresponding one of multiple discharge rate limits in a different amount of time.

10. The system of claim 9, wherein each of the plurality of EWMAs is calculated based on a different averaging constant, the different averaging constants being defined to ensure that the EWMAs associated with progressively higher discharge levels each reach associated discharge rate limits in progressively shorter time increments.

11. The system of claim 10, wherein a length of time that the discharge rate is maintained at each of the multiple discharge rate limits is based on the averaging constant that is predefined with respect to each of the multiple predefined discharge rate levels.

12. The system of claim 9, wherein incrementally decreasing the discharge rate of the battery further comprises:
incrementally decreasing a discharge rate of the battery to cap a maximum time duration that the battery spends continuously discharging at each of the multiple discharge rate limits each defined in association with one of the multiple predefined discharge rate levels.

13. The system of claim 8, wherein the power controller is further configured to:
determine that the EWMA for a particular one of the multiple predefined discharge rate levels has exceeded an associated discharge rate limit;
prohibit the discharge rate of the battery from discharging at the associated discharge rate limit until the EWMA for the discharge rate level again drops below the associated discharge rate limit.

14. The system of claim 8, wherein the power controller is further configured to:
decrease a discharge rate of the battery responsive to determining that a select one of the plurality of EWMAs has reached the corresponding discharge rate limit of the multiple discharge rate limits.

15. One or more computer-readable storage media storing computer-executable instructions for executing a computer process comprising:
sampling a power consumption parameter for a device throughout a time interval in which an increased load transient is observed;
dynamically calculating one or more exponential weighted moving averages (EWMAs) based on the power consumption parameter responsive to each sampling of the power consumption parameter;
increasing a maximum discharge rate of a battery to a discharge rate limit associated with a select maximum level of multiple predefined discharge rate levels; and
as the EWMAs increase following the increased load transient, incrementally decreasing the maximum discharge rate of the battery from the discharge rate limit of the select maximum level to one or more lower discharge rate limits associated with progressively lower levels of the multiple predefined discharge rate levels.

16. The one or more computer-readable storage media of claim 15, wherein dynamically calculating one or more EWMAs further comprises:
calculating a plurality of EWMAs based on the sampled power consumption parameter, each one of the plurality of EWMAs being associated with a different one of the multiple predefined discharge rate levels and defining an exponential curve that rises to a corresponding one of multiple discharge rate limits in a different amount of time.

17. The one or more computer-readable storage media of claim 16, wherein each of the plurality of EWMAs is calculated based on a different averaging constant, the averaging constants being defined to ensure that the EWMAs associated with progressively higher discharge levels each reach associated discharge rate limits in progressively shorter time increments.

18. The one or more computer-readable storage media of claim 17, wherein a length of time that the discharge rate is maintained at each of the multiple discharge rate limits is based on the averaging constant that is predefined with respect to each of the multiple predefined discharge rate levels.

19. The one or more computer-readable storage media of claim 16, wherein incrementally decreasing the discharge rate of the battery further comprises:
incrementally decreasing a discharge rate of the battery to cap a maximum time duration that the battery spends continuously discharging at each of the multiple discharge rate limits each defined in association with one of the multiple predefined discharge rate levels.

20. The one or more computer-readable storage media of claim 16, wherein the computer process further comprises:
determining that the EWMA for a particular one of the multiple predefined discharge rate levels has exceeded an associated discharge rate limit;
prohibiting the discharge rate of the battery from discharging at the associated discharge rate limit until the EWMA for the discharge rate level again drops below the associated discharge rate limit.
